(19) United States
(12) Patent Application Publication
(10) Pub. No.: US 2006/0242847 A1
(43) Pub. Date: Nov. 2, 2006

(54) Razor handle and method for making same

(75) Inventors: Paul Dansreau, Shelton, CT (US); Philipp Pfenniger, Triengen (CH); Andrew Hitchcock, West Haven, CT (US); Andrew Pennella, Stamford, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/398,263

(22) Filed: Apr. 4, 2006

Related U.S. Application Data
(60) Provisional application No. 60/668,826, filed on Apr. 5, 2005.

(51) Int. Cl. B26B 21/00

(52) U.S. Cl. 30/526

(57) ABSTRACT

According to the present invention, a razor handle includes a connecting pod and a first handle portion. The connecting pod has a cartridge-connecting member, and a handle-connecting member. The first handle portion includes a pod-connecting member, and includes a first molded portion, a battery-powered device, and a second molded portion. The battery-powered device is at least partially encased between the first molded portion and the second molded portion. The handle-connecting member of the connecting pod is connected to the pod-connecting member of the first handle portion such that the connecting pod and the first handle portion are not detachable during normal use of the razor handle. The cartridge-connecting member of the connecting pod is operable to connect to a selectively detachable razor cartridge.

### CROSS REFERENCE TO RELATED APPLICATIONS

This application is entitled to the benefit of and incorporates by reference the disclosure of U.S. Patent Application 60/668,826 filed on Apr. 5, 2005 entitled “Razor Handle and Method for Making Same.”

### BACKGROUND OF THE INVENTION

1. Field of the Invention

The present invention relates generally to handles for shaving implements, and, more particularly, to a process for manufacturing a handle having a battery-powered device therein.

2. Description of the Prior Art

Modern shaving implements can include a plurality of blades disposed within a razor cartridge. The razor cartridge is, in turn, mounted on a handle during use. Some safety razors have a disposable razor cartridge that is selectively detachable to a reusable handle, while others have a handle and a razor cartridge that are manufactured as a single, disposable unit.

In those handles that connect to a selectively detachable razor cartridge, it has been found that injection molding at least a portion of the handle has certain advantages. For example, injection molding is a relatively inexpensive method of forming a contoured handle having any number of features. In addition, the handle can be formed through a series of injection molding steps, which can provide additional benefits, such as, but not limited, to several colors, textures, elasticities, and/or features that can not be achieved during a single injection molding process.

Handles that are formed using multiple injection molding steps allow for additional features to be captured between the molded portions of the handle. However, these handles include cartridge-connecting members, which are operable to connect the razor cartridge to the razor handle, and which typically require several moving features made from distinct parts that are assembled. Because the cartridge-connecting members have moving features that are assembled, it is often impossible or at least not conducive to injection mold an entire handle through a series of injection molding steps.

It is, therefore, an object of the present invention to overcome the known shortcomings of the prior art.

### SUMMARY OF THE DISCLOSURE

According to the present invention, a razor handle includes a connecting pod and a first handle portion. The connecting pod has a cartridge-connecting member, and a handle-connecting member. The first handle portion includes a pod-connecting member, and includes a first molded portion, a battery-powered device, and a second molded portion. The battery-powered device is at least partially encased between the first molded portion and the second molded portion. The handle-connecting member of the connecting pod is connected to the pod-connecting member of the first handle portion such that the connecting pod and the first handle portion are not detachable during normal use of the razor handle. The cartridge-connecting member of the connecting pod is operable to connect to a selectively detachable razor cartridge.

One advantage of the present invention is that the first handle portion can be formed quickly, and inexpensively, in a manner that allows for any number of features, colors, and contours. Another advantage of the present invention is that the connecting pod may be assembled in a separate operation, then attached to the first handle portion.

These and other advantages of the present invention will be apparent to one skilled in the art in light of the FIGS, Detailed Description, and Claims.

### BRIEF DESCRIPTION OF THE DRAWINGS

FIG. 1 is a perspective view of one embodiment of the present invention with a razor cartridge mounted thereon;

FIG. 2 is a sectional view of FIG. 1 along line 2-2;

FIG. 3 is a side exploded view of the shaving implement of FIG. 1;

FIG. 4 is a side exploded view of the shaving implement of FIG. 1 wherein a razor cartridge is removably attached to the connecting pod; and

FIG. 5 is a front view of one embodiment of the connecting pod of FIG. 4.

### DETAILED DESCRIPTION

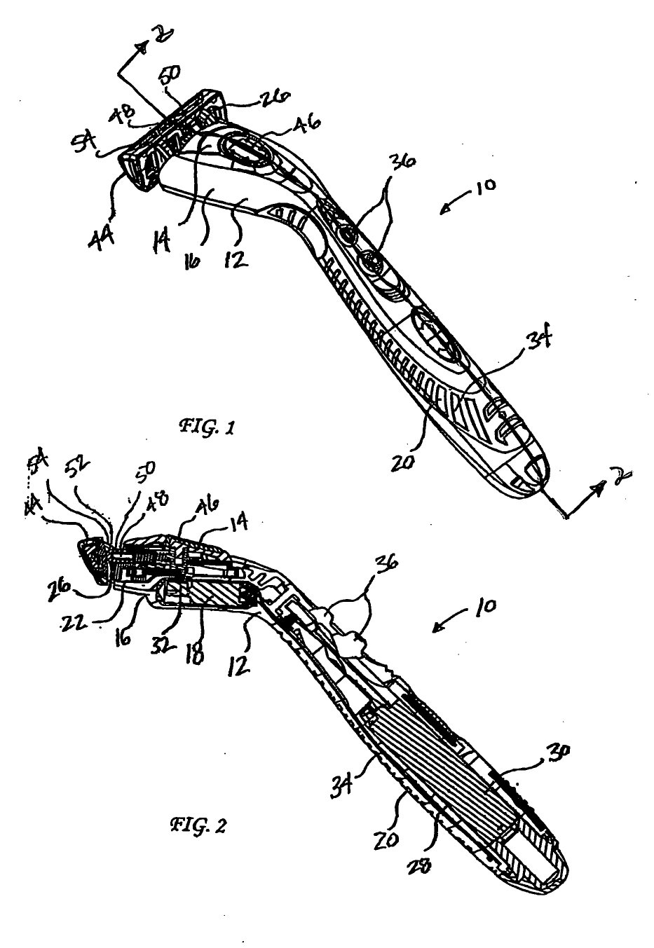

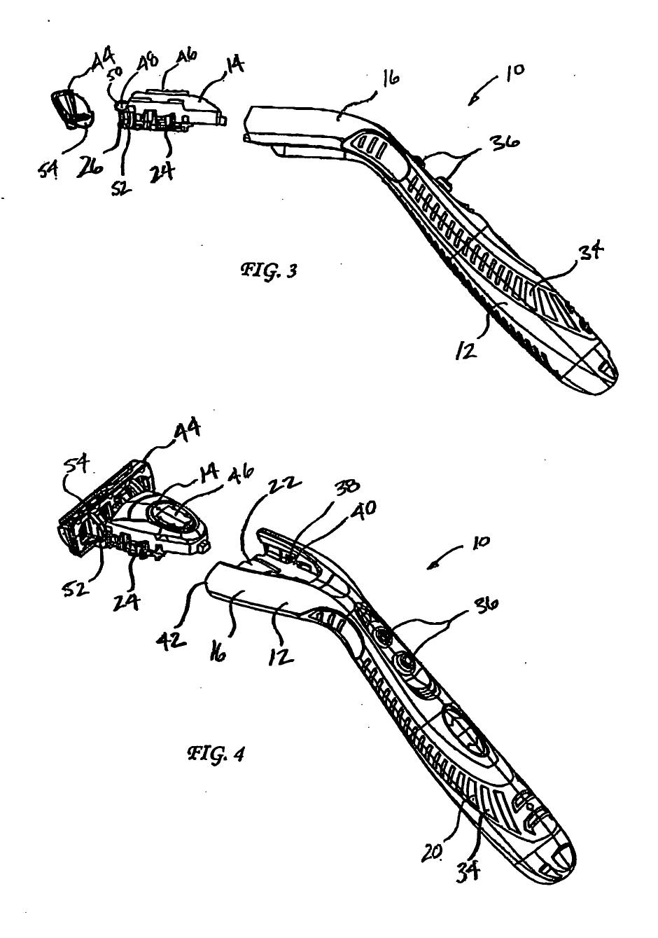

Referring to FIGS. 1-2, a razor handle 10 includes a first handle portion 12, and connecting pod 14. The first handle portion 12 includes a first molded portion 16, a battery-powered device 18, a second molded portion 20, and an auxiliary cavity 22. The connecting pod 14 includes a handle-connecting member 24 and a razor cartridge-connecting member 26.

The first handle portion 12, as mentioned above, includes a first molded portion 16, a battery-powered device 18, a second molded portion 20, and an auxiliary cavity 22. In some embodiments, the first handle portion 12 may also include a cavity 28 for housing a battery 30 (see FIG. 2). The first molded portion 16 can be formed of a rigid molded material that provides the razor handle 10 with the necessary mechanical strength. For example, the first mold portion 16 may be made of Glass Fiber Polypropylene (“GFPP”), which has proven to have desirable density (1.00 g/cm³), tensile strength (87 MPa), and flexural strength (108 MPa), as well as an appropriate hardness (Rockwell Hardness R-scale 111). GFPP supplies a desirable balance of mechanical properties for providing the razor handle 10 with weight, structural stability, as well as an attractive finish. However, the first molded portion 16 may made of any suitable material.

Referring to FIG. 2, the battery-powered device 18 can be any device that provides some additional benefit to the end user. For example, in a preferred embodiment, the battery-powered device 18 is a motor that spins an eccentric weight 32. In some embodiments, the battery-powered device 18 further includes wiring, switch(es), sensor(s), and/or other additional electronic components. Naturally, the battery-powered device 18 is connected to a battery 30.

Referring back to FIG. 1, the second molded portion 20 is injection molded onto the first molded portion 16, and at least partially encases the battery-powered device 18. Preferably, especially in embodiments utilizing a motor that spins an eccentric weight 32, the battery-powered 18 device is completely encased within the second molded portion 20 and the first molded portion 16. Completely encasing the battery-powered device 18 between the second molded portion 20 and the first molded portion 16 substantially protects the battery-powered device 18 from coming into contact with water and other substances that may affect the operability of the device 18.

In some embodiments, the second molded portion 20 can be formed of thermoplastic rubber (“TPE”), and preferably VYRAM® rubber 9211-35W906 that is commercially available through Advanced Elastomer Systems (AES) of Akron, Ohio, USA. The TPE material identified above has desirable hardness (45 Shore A), specific gravity (0.92), (ultimate) tensile strength (3.0 MPa), (ultimate) elongation (450%). The TPE material also has desirable compressive qualities, which are useful for creating various razor handle features, such as, but not limited to, gripping structures 34 (discussed infra). However, any suitable material known to those of skill in the art can be used in place of the above-identified material.

The second molded portion 20, as mentioned, may also be utilized to form additional features on the first handle portion 12. For example, the second molded portion 20 may form at least a portion of the auxiliary cavity 22, cavity 28, gripping structures 34 (see e.g., FIG. 1), On/Off buttons 36 for the battery-powered device 18 (see e.g., FIG. 1), and/or pod connecting members 38 (discussed infra). Furthermore, the second molded portion 20 may be a single, unitary piece, or may be several separate elements, as shown in FIG. 1.

Referring again to FIG. 2, the first handle portion 12 can form a cavity 28 sized for receiving at least a portion of a battery 30. The cavity 28 may be formed of the first molded portion 16 and/or the second molded portion 20. Using the materials listed above, it is preferable that the cavity 28 be formed primarily of the first molded portion 16 because of its rigidity and hardness. The GFPP material provides a more stable cavity 28 material that is less likely to undesirably change shape during the life of the first handle portion 12 than does the TPE. In some embodiments, the cavity 28 is sized for receiving at least a portion of a standard, AAA-sized battery, as shown in FIG. 6. However, the cavity 28 may also be sized to receive at least a portion of any sized battery 30. Preferably, the cavity 28 is oriented within the razor handle 10 such that the razor handle 10 is ergonomically shaped.

Alternatively, and although not shown, a battery 30 may be entirely encased in, or in between, the first and/or second molded portions of the first handle portion. Such a situation may be especially useful in a disposable-type razor that is intended to be discarded once the battery 30 has expired.

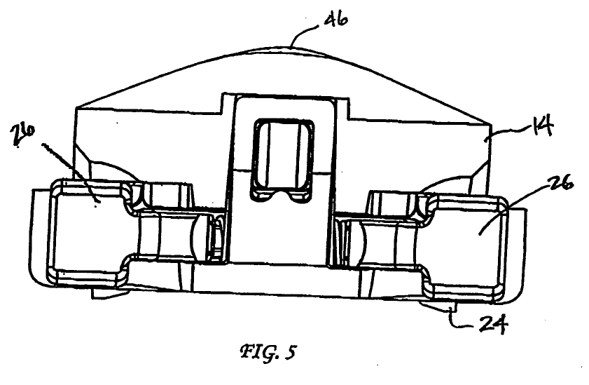

Referring now to FIGS. 3-4, the first handle portion 12 includes an auxiliary cavity 22. The auxiliary cavity 22 can include a pod-connecting member 38, and is sized and shaped to receive a connecting pod 14. The pod-connecting member 38 may include, for example, one or more slots 40 in the auxiliary cavity 22 into which complimentary handle-connecting member(s) 24 (discussed infra) on the connecting pod 14 fit. Alternatively, the auxiliary cavity 22 can be one or more protrusions (not shown) that fit into complimentary slots (not shown) on the connecting pod 14.

The auxiliary cavity 22 is typically located near one end 42 of the first handle portion 12. Therefore, when the connecting pod 14 is attached, the cartridge-connecting members 26 (discussed infra) on the connecting pod 14, the razor cartridge 44 can be conveniently releasably secured to the razor handle. The auxiliary cavity 22, naturally, is sized and shaped to receive the connecting pod 14.

Referring now to FIGS. 3-5, the connecting pod 14 is typically pre-assembled, and includes a cartridge-connecting member 26, and a handle-connecting member 24. In most embodiments, the connecting pod 14 further includes a release mechanism 46 and a biasing member 48. The biasing member 48 is operable to urge the razor cartridge 44 toward a rest position (shown in FIG. 3), but is able to allow the razor cartridge 44 to pivot relative to the handle (not shown) when forces are placed on the razor cartridge 44. As shown the biasing member 48 is a spring-loaded plunger 50; however, any suitable biasing member 48, such as a leaf spring (not shown) may be utilized. As discussed above, the handle-connecting member 24 of the connecting pod 14, and the pod-connecting member 38 of the first handle portion 12 cooperate to connect the connecting pod 14 and the first handle portion 12. Together, once connected, the connecting pod 14 and the first handle portion 12 are typically not intended to be separated during normal use.

The cartridge-connecting member 26 may any one of numerous types of cartridge connector members 26 known in the art, and may connect to the cartridge 44 in either a fixed manner, or a pivotal manner. For example, as shown in FIGS. 4 and 5, the cartridge-connecting member 26 includes at least two journal bearings 52 which mate with complimentary connectors 54 on an associated razor cartridge 44. When connected, the razor cartridge 44 can, in some embodiments, pivot relative to the razor handle 10. In addition, and although not shown, an inter-connect member may be attached to the razor cartridge 44 such that the razor cartridge 44 pivots relative to the inter-connect member (and, accordingly, the handle 10). However, in these embodiments, the inter-connect member is fixedly attached in any suitable manner to the connecting pod 14. The release button 46 may be of any suitable type. In the embodiment shown, the release button 46 pivots the cartridge-connecting members 26 inward, which, in turn, releases the razor cartridge 44.

As discussed above, the handle-connecting member(s) 24 are complimentary to the pod-connecting member(s) 38 of the first handle portion 12. The handle-connecting member(s) 24, as noted above, may be any suitable type and may be “male” or “female”.

One method for making the razor handle 10 of the present invention includes the following steps. The first molded portion 16 of a first handle portion 12 is injection molded. The battery-powered device 18 is then secured to the first molded portion 12 of the first handle portion 12. The second molded portion 20 of the first handle portion 12 is then injection molded such that at least a portion of the battery-powered device 18 is encased in the first handle portion 12 (e.g., between the first and second molded portions 16, 20). The connecting pod 14 is assembled and attached to the first handle portion 12 by connecting the pod-connecting member(s) 38 of the first handle portion 12 to the handle-connecting member(s) 24 of the connecting pod 14.

In some embodiments, although not shown, the first handle portion 12 may include additional molded portion(s). The additional portion(s) may be formed at any point in time during before, during or after the two (2) injection molding processes described in the preceding paragraph.

In use, the user couples a razor cartridge 44 to the cartridge-connecting member(s) 26 of the connecting pod 14, activates the battery-powered device 18, and proceeds to shave unwanted hair from a surface. Upon finishing shaving, the user selectively de-activates the battery-powered device 18 when the razor handle 10 is not in use.

Modification and variations may be made to the disclosed embodiments without departing from the subject and spirit of the invention as defined by the following claims. For example, although not shown, additional measures can be taken to prevent the first handle portion 12 and the connecting pod 14 from separating. For example, in some instances, a rivet or screw (not shown), may be used to secure the first handle portion and the connecting pod together in addition to, or in place of, the pod-/handle-connecting member(s) 38,24 of the first handle portion 12 and connecting pod 14, respectively.

What is claimed is:

1. A razor handle, comprising:
a connecting pod having a handle-connecting member and a cartridge-connecting member, the cartridge-connecting member being operable to connect to a selectively detachable razor cartridge;
a first handle portion having a first molded portion, a battery-powered device, a second molded portion and an auxiliary cavity having a pod-connecting member, the battery powered device being at least partially encased between the first molded portion and the second molded portion; and
wherein the handle-connecting member of the connecting pod is connected to the pod-connecting member in the auxiliary cavity of the first handle portion such that the connecting pod and the first handle portion are not detachable during normal use of the razor handle.

2. The razor handle of claim 1, wherein the battery-powered device is a motorized spinning eccentric weight.

3. The razor handle of claim 1 wherein the connecting pod includes a release mechanism for selectively detaching the razor cartridge from the connecting pod.

4. The razor handle of claim 1 wherein the cartridge-connecting member pivotally connects to the selectively detachable razor cartridge.

5. The razor handle of claim 1, the first molded portion being formed from a rigid material.

6. The razor handle of claim 1, the battery-powered device being completely encased within the second molded portion and the first molded portion.

7. The razor handle of claim 1, the second molded portion being formed of a thermoplastic material.

8. The razor handle of claim 1, wherein the first handle portion includes a cavity sized for receiving at least a portion of a battery, the cavity being formed from at least one of the first molded portion and the second molded portion.

9. The razor handle of claim 1, wherein at least one of the first molded portion and the second molded portion entirely encases a battery.

10. A connecting pod for a razor handle, comprising:
a cartridge-connecting member operable to connect to a selectively detachable razor cartridge; and
a handle-connecting member attached to the cartridge-connecting member, the handle-connecting member operable to connect to a pod-connecting member on a handle having a battery-powered device therein;
wherein the handle-connecting member and the pod-connecting member are not intended to be separable during normal use of the razor handle.

11. The connecting pod of claim 10, wherein the connecting pod further includes a release mechanism for selectively detaching the razor cartridge from the connecting pod.

12. The connecting pod of claim 10, wherein the cartridge-connecting member pivotally connects to the selectively detachable razor cartridge.

13. The connecting pod of claim 10, including a release mechanism and a biasing member, the biasing member being operable to urge the detachable razor cartridge toward a rest position and to allow the detachable razor cartridge to pivot relative to the handle in response to forces applied thereto.

14. The connecting pod of claim 13, wherein the biasing member is a spring loaded plunger.

15. The connecting pod of claim 10, wherein the cartridge-connecting member includes at least two journal bearings operable to mate with connectors positioned on the detachable razor cartridge.

16. A method for making a handle for a shaving implement, the steps for making the handle, comprising:
assembling a connecting pod having a cartridge-connecting member and a handle-connecting member, wherein the cartridge-connecting member is operable to receive a selectively detachable razor cartridge;
injection molding a first molded portion of a first handle portion;
placing a battery-powered device on the first molded portion of the first handle portion;
injection molding a second molded portion of the first handle portion, wherein the second molded portion of the first handle portion at least partially encases the battery-powered device in the first handle portion; and
connecting the handle-connecting member of the connecting pod to the first handle portion in a manner such that the connecting pod is not detachable from the first handle portion during normal use of the shaving implement.

17. The method for making a handle for a shaving implement of claim 16 further including connecting the selectively detachable razor cartridge to the cartridge-connecting member of the connecting pod.

18. The method for making a handle for a shaving implement of claim 16, wherein the connecting pod includes a release mechanism for selectively detaching the razor cartridge from the connecting pod.
